(19) United States
(12) Patent Application Publication
(10) Pub. No.: US 2011/0112880 A1
(43) Pub. Date: May 12, 2011

(54) ALLOCATION OF COMMON RESOURCES IN AN ENTITY

(75) Inventors: Shannon M. Ryan, San Jose, CA (US); Lisa Oda, San Carlos, CA (US)

(73) Assignee: eBay Inc., San Jose, CA (US)

(21) Appl. No.: 12/886,828

(22) Filed: Sep. 21, 2010

Related U.S. Application Data
(60) Provisional application No. 61/244,828, filed on Sep. 22, 2009.

(51) Int. Cl. G06Q 10/00

(52) U.S. Cl. 705/7.16; 705/7.12; 705/7.13

(57) ABSTRACT

Systems and methods for allocation of common resources in an entity are provided. Various programs within the entity each utilize a shared resource. In an example embodiment, a method comprises receiving a ranking of programs within the entity. The method also includes identifying common tasks and an amount of time required to complete each respective common task. Upon receiving a set of desired tasks associated with each of the programs, a desired budget is determined for each of the programs. The method results in allocating the common resource based on the ranking and the respective desired budget of the programs.

### RELATED APPLICATIONS

This non-provisional U.S. patent application claims the priority benefit of U.S. provisional patent application No. 61/244,828 filed Sep. 22, 2009 and entitled “Allocation of Common Resources in an Entity,” which is hereby incorporated by reference herein.

### TECHNICAL FIELD

Embodiments of the present invention relate generally to enterprise resource planning and more specifically to systems and computer-implemented methods for identifying and prioritizing tasks to be performed by a set of limited resources.

### BACKGROUND

In large entities (e.g., business and government entities), many resources are shared among various programs or business units within the entity. These shared resources typically include one or more employees that have a particular skill set. Examples of shared resources include, for example, marketing departments, customer relationship management personnel, legal departments, accounting and budgeting departments, research departments, model-making personnel, drafting personnel, secretarial pools, and the like. Typically, the use of these resources within the entity are budget-neutral (i.e., “free”) or heavily subsidized (i.e., “cheap”) from the perspective of the individual business units. Further, the use of the shared resources may not be closely monitored by high-level executives in the entity. Consequently, it is often difficult to assess the actual capacity of a particular resource or set of resources, and difficult to prioritize the tasks assigned to the resources.

### BRIEF DESCRIPTION OF THE DRAWINGS

FIG. 1 is a block diagram of an example management system for allocating shared resources available to an entity, consistent with some embodiments of the invention.

FIG. 2 is a flowchart of an example approach for allocating shared resources in an entity, consistent with some embodiments of the invention.

FIG. 3 is a task menu providing information about the services (tasks) provided by a particular set of resources, according to various embodiments of the invention.

FIG. 4 is an example of an allocation table that may be generated according to various embodiments of the invention.

FIG. 5 is an example of a computer system according to various embodiments of the invention.

### DETAILED DESCRIPTION

Shared resources available to various programs or business units in a large organization or entity may be able to perform a limited number of tasks within a given time period. The shared resources are typically limited by the number of employees and by the number of hours each of those employees is able to perform a particular task during the given time period. In practice, the shared resources may be over-utilized or under-utilized by the programs or business units. Further, because the shared resources are not assigned to a single program or business unit, a shared resource may lack oversight or guidance from upper management groups regarding priorities.

While an entity may track costs associated with external resources such as law firms, advertising firms, contractors, or consultants, the entity may be unwilling or unable to track the use of internal shared resources. Further, the entity may find it too expensive on an operational level to track shared resources in the same manner that the entity tracks the use of external resources. In some instances, employees associated with the shared resources may resist having to submit detailed reports of their efforts.

Various embodiments may provide a way for entities to track the use of shared resources without unduly burdening the employees associated with the shared resources with reporting requirements. Alternatively or additionally, embodiments may provide a way to allocate the shared resource to the programs based on entity-wide priorities and/or the needs of the programs or business units.

A marketing department may be a shared resource within a large organization. The employees in the marketing group have varied skills, such as graphics design, rich media generation, database management, copy editing, etc. Collectively, these employees can perform only so many specific tasks in a month. For example, tasks might include the creation of brochures, marketing emails, newsletters, web pages, graphics, logos, and the like.

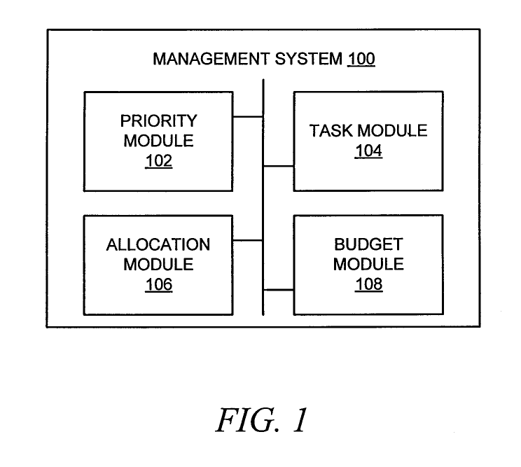

FIG. 1 is a block diagram of an example management system 100 for allocating common resources in an entity. The example management system 100 may be implemented using one or more computers connected via a public and/or private network. The management system 100 may comprise a priority module 102, a task module 104, an allocation module 106, and a budget module 108.

The priority module 102 may determine or receive a ranking of programs. The term “program” as used herein refers generally to a sub-organization that is a consumer of the shared resource within the organization. Examples of programs include a business unit, a task force, a department, a branch, a project team, or the like. The ranking of programs may be based on a number of objective and/or subjective factors. Some objective factors may include: relative performance of the programs over a predetermined period of time, relative use of the shared resource buy the programs over a predetermined period of time, and the like.

Some subjective factors may include: entity-wide business goals, entity-wide business priorities, and needs of the entity itself. For example, a program may be ranked higher (i.e., have a higher priority) temporarily to achieve an entity-wide business goal, such as a marketing push for a particular program. Examples of entity-wide business priorities that may be ranked higher include programs to maintain or improve the reputation of the entity overall. For example, customer loyalty programs or customer service programs may be ranked higher than other programs.

The task module 104 receives one or more common tasks performed by the resource and determines an aggregate amount of personnel time required by the common resource to perform the respective common tasks. The aggregate amount of time may be determined by receiving an estimate of time to perform a common task (or sub-task) from one or more personnel and adding the time to generate a sum. In some instances, the task module may receive a time to perform a common task on separate occasions from a single person and may average the times to determine an amount of time for that person.

In some embodiments, the task module 104 may further assign a time-quantifier to the common task based on the aggregate amount of time. The time-quantifier may be used to add some flexibility into the management system in cases where, for example, a common task takes longer than expected to complete. The time-quantifier may be a pre-determined unit of time, e.g., five hours.

Based on the ranking of the programs generated by the priority module 102 and an amount of time of the shared resource that is available for a given time period (e.g., one month), the allocation module 106 allocates a portion of the shared resources to the respective programs. The allocation may be over a period of time, e.g., one month.

To determine the available time of the shared resource, the allocation module 106 may receive a number of personnel-hours that the shared resource has available in the given time period. The number of personnel-hours may be expressed using a time-quantifier. The number of personnel-hours is calculated based on the number of personnel in the common resource and the number of hours each employee is expected to work at the tasks per week or per month. In some instances, the number of personnel-hours may be based on which common tasks each employee is able to perform. These hours may be adjusted by, for example, scheduled leave, experience level, terminations or new hires.

In the instance of calculating hours based on experience level, a more experienced person may be expected to perform a given common task faster than a less experienced person. A weighting factor may be applied to at least a portion of the personnel hours of each personnel to effectively allocate more actual time for the less experienced person to perform a task and/or less actual time for the more experienced person to perform a task.

The allocation module 106 may additionally receive a set of desired tasks from each respective program or business unit for a given time period. The set of desired tasks is used to generate a desired budget for each respective program or business unit. The set of desired tasks may correspond to a future time period such as the next month or the next quarter. The desired budget may be a sum of the aggregate amount of time determined for each task within the set of desired tasks.

The allocation module 106, using the desired budget of each program and the ranking of the respective program, allocates the number of personnel-hours among the programs. The allocation may be performed such that the programs having a relatively higher priority are allocated a greater percentage of their desired budgets than programs having a relatively lower priority. In instances where a single program desires a disproportionally large portion of the number of personnel hours, the single program or business unit may be allocated a lesser percentage of its desired budget but still more total personnel hours than a program having a lower priority.

Once the personnel-hours are allocated, the budget module 108 provides the allocated actual budget to the respective programs or business units. The budget module 108 may then receive a revised set of desired tasks based on the actual budget. The revised set of tasks may or may not be a subset of the originally submitted desired set of tasks.

In some instances, once the personnel-hours are allocated, the ranking may change and/or one or more allocations to the programs may be modified. For example, in the context of shared marketing resources, a program or business unit utilizing the marketing resources may require additional services from the shared resource to complete a “rush task” to, for example, respond to a news story, a competitor's announcement, or other development. The allocation may be modified by, for example, changing the ranking of the affected program or by receiving an instruction from a user to increase the number of personnel-hours allocated to the program by a specified number or a specified percentage.

In response to the change in allocation, the allocation module 106 determines a new allocation of the personnel hours by reducing the number of personnel hours allocated to other programs. In this way, some embodiments improve transparency in the allocation of shared resources available to an entity by dynamically presenting how the shared resources are allocated among the various programs or business units. Further, the respective programs or business units can track the usage of the shared resource over a period of time. Entity-wide, the management system 100 can be used to communicate entity-wide priorities and allocate resources to achieve objectives associated with those priorities.

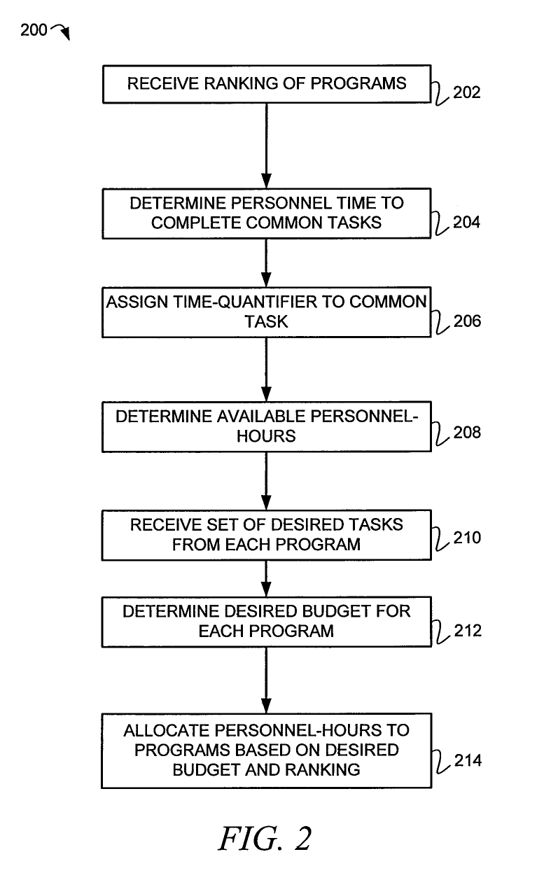

FIG. 2 is a flowchart of an example approach 200 for allocating shared resources in an entity. The example approach 200 may be performed by the management system 100.

In an operation 202, the ranking of programs is received by the priority module 102. The ranking may include a priority number or weighting factor associated with each of the programs within the ranking. Step 202 may be repeated on a periodic basis (e.g., once a month, once per quarter, or once per year) and/or on an ad hoc basis. In some instances, the ranking may change according to seasonal changes. For example, the ranking may change for the holiday shopping season, tax time, and the like.

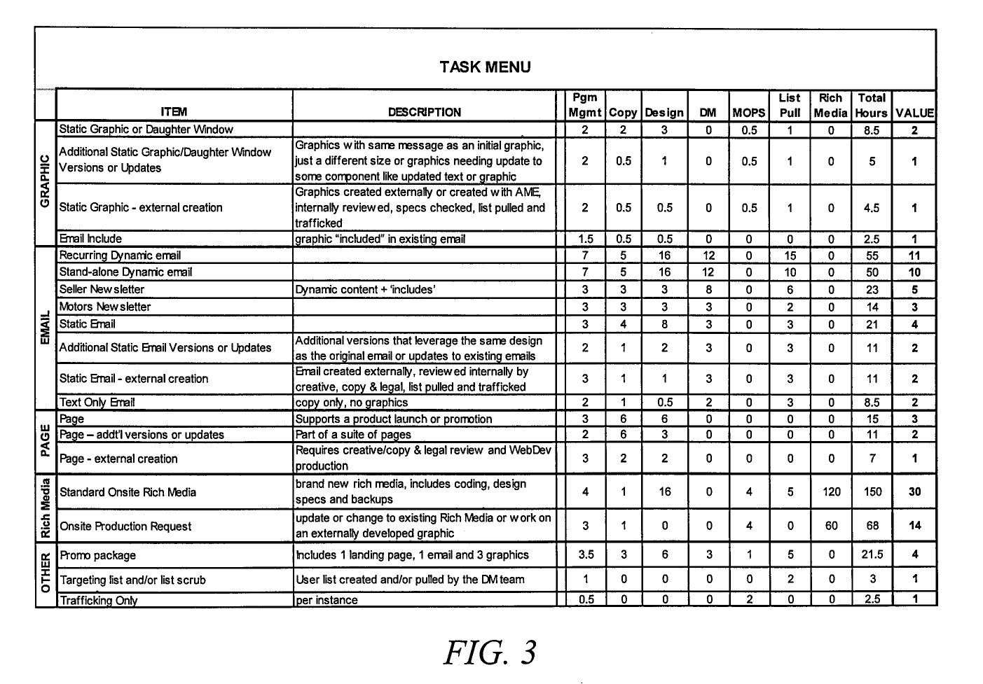

In an operation 204, the personnel time to complete common tasks is determined by the task module 104. This information may be summarized in a “Task Menu” an example of which is included in FIG. 3. Generally, the Task Menu includes a listing of one or more common tasks and an estimate of the personnel time required by the shared resource to perform the task. The Task Menu of FIG. 3 further includes a type of the task (e.g., graphic, email, page, Rich media, and other) and a description of each task for ease of use.

The example task menu of FIG. 3 further shows a breakdown of the personnel time according to the role of the people performing the task. These roles include, program management, copy, design, data management (DM), MOPS, list pull, and rich media. The sum of the amount of time each respective role requires for the common task is listed in the column, “Total Hours.”

In an optional operation 206 and as shown in the Task Menu of FIG. 3, the total hours are, in turn, used to assign a time-quantifier (“VALUE” column) to the task. In the example shown, the time quantifier is the number of five hour segments of time required to complete the task. Where the total hours comprise a fraction of a five hour segment, the time-quantifier is rounded to the next whole number. Alternatively, the time-quantifier for a particular task may include a fraction of the segment of time.

The operation 204 may be repeated in whole or in part to add and/or remove common tasks from the Task Menu. Further, the operation 204 may include updating the hours of one or more existing roles within the shared resources, which in turn, may affect the “total hours” and/or “value” of the task.

In an operation 208, the available personnel hours are determined. The available personnel hours are discussed in greater detail in connection with the allocation module 106. The operation 208 may be performed periodically and/or as needed to update the number of available personnel-hours. The available personnel-hours may be based on a particular skill set of each employee, departures, new hires, scheduled leave, etc.

In an operation 210, a set of desired tasks to be performed by the shared resource is received from each program. The set of desired tasks may be received on a periodic basis (e.g., monthly) and/or on ad hoc basis. The desired budget is calculated based on the tasks in the set of desired tasks and the total hours or time-quantifier associated with the task in the task menu in an operation 212.

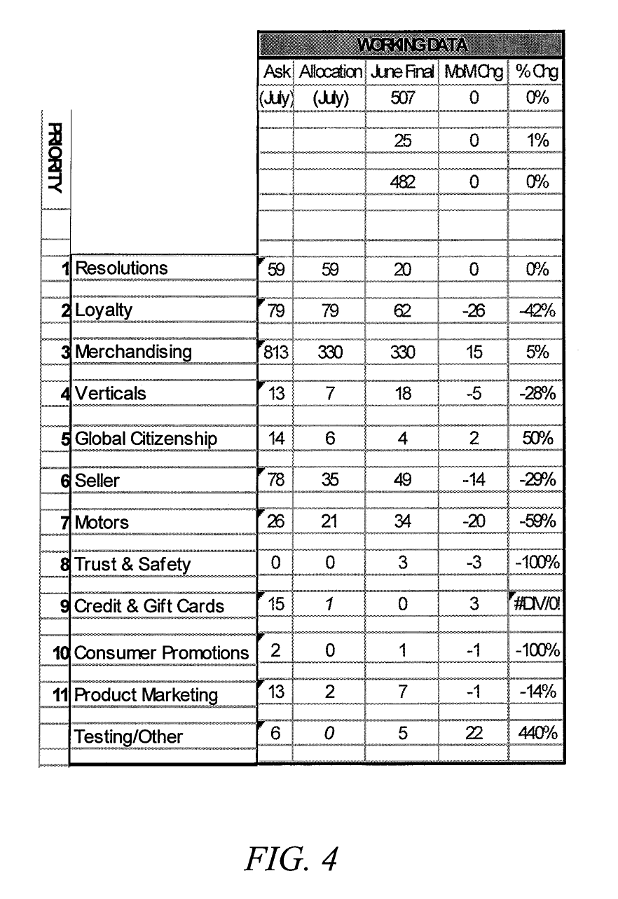

In an operation 214, the personnel-hours are allocated to the programs based on a desired budget and ranking of the respective programs. An example allocation table that may be generated according to various embodiments is provided in FIG. 4. The allocation table may express the personnel hours in terms of actual hours or as a time-quantifier. The table lists the various programs in descending order from highest priority (i.e., ranking of 1) to lowest priority (i.e., ranking of 11). In an “Ask” column, the desired budget is expressed shown for a period of time (e.g., one month). The “Allocated” column shows the allocation to the program for that period of time.

In the column labeled “June Final,” the actual amount of personnel-hours used by the program in the previous time period is provided. The actual amount may be tracked, for example, to modify the ranking, determine if the allocation is realistic, or for another reason. The “Month over Month Change” (i.e., MoM Chg) column shows the change in the number of hours allocated to the program as compared to the previous month's allocation. The “Percent Change” column shows the month over month change in the percentage of hours allocated to each program. These columns may help in identifying trends.

It is noted that the programs having a higher ranking are generally allocated a larger portion of their desired budget. For example, the resolutions and loyalty programs each receive 100% of their desired budget. Merchandising, having a very large desired budget, still receives a significantly larger number of personnel-hours relative to the other programs by virtue of having a ranking of “3”. The remaining programs receive smaller portions of their desired budgets and some programs do not receive any personnel hours. Upon receiving the allocation, the programs may modify or pare down their desired set of tasks.

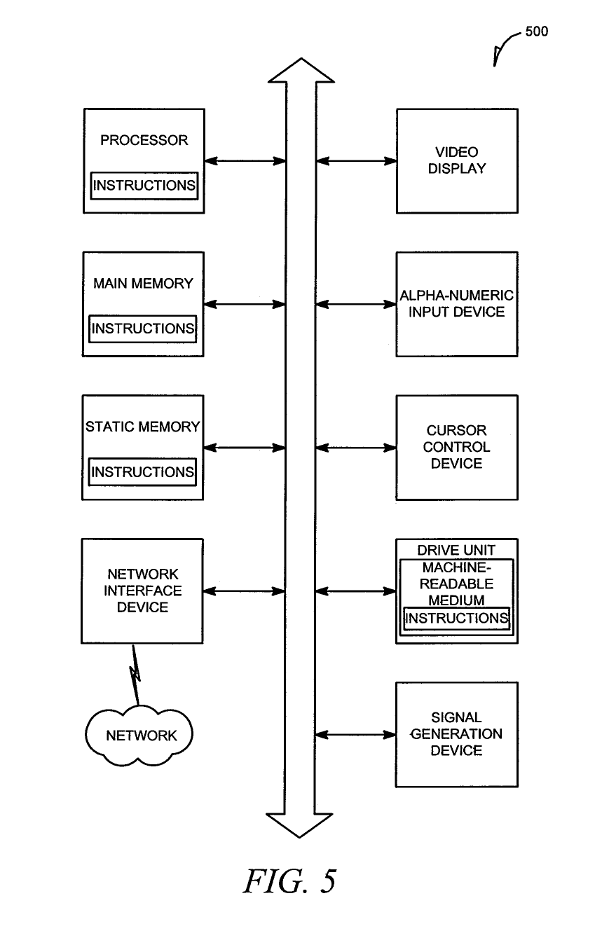

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor (e.g., a central processing unit (CPU), a graphics processing unit (GPU), or both), a main memory and a static memory which communicate with each other via a bus. The computer system 500 may further include a video display unit (e.g., a liquid crystal display (LCD) or a cathode ray tube (CRT)). The computer system 500 also includes an alphanumeric input device (e.g., a keyboard), a cursor control device (e.g., a mouse), a disk drive unit, a signal generation device (e.g., a speaker) and a network interface device.

The disk drive unit includes a machine-readable medium on which is stored one or more sets of instructions (e.g., software) embodying any one or more of the methodologies or functions described herein. The software may also reside, completely or at least partially, within the main memory (and/or the static memory) and/or within the processor during execution thereof by the computer system 500, with the main memory and the processor also constituting machine-readable media.

The software may further be transmitted or received over a network via the network interface device.

While the machine-readable medium is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain embodiments are described herein as including logic or a number of components, modules, or mechanisms. Modules may constitute either software modules (e.g., code embodied on a machine-readable medium or in a transmission signal) or hardware modules. A hardware module may be a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs.)

Thus, a method and system to allocate a common resource within an entity have been described. Although the present invention has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving a ranking of programs within an organization, the programs within the organization each utilizing a shared resource;
identifying a plurality of common tasks each having a weight proportional to an amount of time required to complete each respective common task;
receiving a set of desired tasks associated with each of the programs within the organization, each task of the desired tasks corresponding to a common task of the plurality of common tasks;
determining a desired budget for each of the respective programs based on the set of desired tasks received from the respective program and the weight of the respective common tasks corresponding to the desired tasks; and
allocating the common resource based on the ranking and the respective desired budget of the programs.

2. The computer-implemented method of claim 1, wherein the shared resource comprises a human resource.

3. The computer-implemented method of claim 1, further comprising:
providing an actual budget to the respective program; and
receiving a revised set of desired tasks from the respective program based on the actual budget.

4. The computer-implemented method of claim 1, wherein the ranking is based on performance of the respective programs.

5. The computer-implemented method of claim 1, further comprising assigning a time-quantifier to the common task.

6. The computer-implemented method of claim 1, further comprising assigning a time-quantifier to the shared resource, the time-quantifier to indicate a number of available personnel hours.

7. The computer-implemented method of claim 6, further comprising applying a weighting factor to at least a portion of the available personnel hours of each personnel.

8. The computer-implemented method of claim 6, further comprising modifying the time-quantifier based on a skill set of a particular employee.

9. The computer-implemented method of claim 6, further comprising modifying the time-quantifier based on a scheduled leave of a particular employee.

10. The computer-implemented method of claim 1, further comprising receiving a rush task from the respective program, and, in response to the rush task, assigning a time-quantifier to the rush task.

11. The computer-implemented method of claim 10, further comprising re-allocating the common resource based on a new ranking of programs.

12. The computer implemented method of claim 10, further comprising receiving an instruction from a user to increase the number of personnel-hours allocated to the respective program, the increase based on the time-quantifier assigned to the rush task.

13. The computer implemented method of claim 10, further comprising reducing an allocation to another respective program based on the time-quantifier assigned to the rush task.

14. A system comprising:
a processor-implemented priority module to receive a ranking of programs within an organization, the programs within the organization each utilizing a shared resource;
a processor-implemented task module to identify a plurality of common tasks each having a weight proportional to an amount of time required to complete each respective common task;
a processor-implemented allocation module to receive a set of desired tasks associated with each of the programs within the organization, each task of the desired tasks corresponding to a common task of the plurality of common tasks and to determine a desired budget for each of the respective programs based on the set of desired tasks received from the respective program and the weight of the respective common tasks corresponding to the desired tasks; and
a processor-implemented budget module to allocate the common resource based on the ranking and the respective desired budget of the programs.

15. The system of claim 14, wherein the shared resource comprises a human resource.

16. The system of claim 14, wherein the budget module is further to provide an actual budget to the respective program and to receive a revised set of desired tasks from the respective program based on the actual budget.

17. The system of claim 14, wherein the task module is further to assign a time-quantifier to the common task.

18. The system of claim 14, wherein the task module is further to assign a time-quantifier to the shared resource, the time-quantifier to indicate a number of available personnel hours.

19. The computer-implemented method of claim 14, wherein the allocation module is to receive a rush task from the respective program, and, in response to the rush task, assigning a time-quantifier to the rush task.

20. A non-transitory computer-readable medium having instructions executable by a processor embodied thereon, the instructions to perform a method comprising:
receiving a ranking of programs within an organization, the programs within the organization each utilizing a shared resource;
identifying a plurality of common tasks each having a weight proportional to an amount of time required to complete each respective common task;
receiving a set of desired tasks associated with each of the programs within the organization, each task of the desired tasks corresponding to a common task of the plurality of common tasks;
determining a desired budget for each of the respective programs based on the set of desired tasks received from the respective program and the weight of the respective common tasks corresponding to the desired tasks; and
allocating the common resource based on the ranking and the respective desired budget of the programs.
